(19) United States
(12) Patent Application Publication
(10) Pub. No.: US 2006/0080428 A1
(43) Pub. Date: Apr. 13, 2006

(54) Method, system and computer program to enable semantic mediation for SIP events through support of dynamically binding to and changing of application semantics of SIP events

(75) Inventors: Dirk Trossen, Cambridge, MA (US); Dana Pavel, Cambridge, MA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/862,868

(22) Filed: Jun. 7, 2004

(51) Int. Cl. G06F 15/173

(52) U.S. Cl. 709/224

(57) ABSTRACT

An event notification system includes a data communications network (18), at least one event server (20) coupled to the data communications network and at least one subscriber (12) coupled to the data communications network. The subscriber is operable to send a subscribe message to the event server, the subscribe message containing information for specifying at least one application semantic. The event server is operable to generate a first notification to the subscriber upon the at least one application semantic being satisfied and to generate a second notification to the subscriber upon a change in the specified application semantic, thereby enabling an occurrence of a substitution of the specified application semantic with another application semantic.

### CROSS-REFERENCE TO RELATED PATENT APPLICATIONS

This patent application is related to the following commonly assigned U.S. patent applications: D. Trossen, “Integration of Service Registration and Discovery in SIP Environments”, Ser. No. 10/179,244, filed Jun. 26, 2002; D. Trossen, “Content and Service Registration, Query, and Notification using SIP Event Packages”, Ser. No. 10/330,146, filed Dec. 30, 2002; D. Trossen, K. Mehta, “Access Control Alert Method using SIP Event Package”, Ser. No. 10/353,014, filed Jan. 29, 2003; D. Trossen, “Querying for SIP Event Packages by Using SIP OPTIONS Method or by Using Service Discovery”, Ser. No. 10/418,313, filed Apr. 18, 2003; and to D. Trossen, D. Pavel, “Application Semantic Binding through SIP Event Package Template”, Ser. No. 10/465,455, filed Jun. 19, 2003, the disclosures of which are incorporated by reference in their entireties.

### TECHNICAL FIELD

This invention relates generally to wireless communications systems and methods and, more specifically, relates to wireless terminals and wireless network nodes that use a Session Initiation Protocol (SIP).

### BACKGROUND

The infrastructure of the Session Initiation Protocol (SIP) is defined in IETF RFC3261 (Rosenberg et al., June 2002). In general, the SIP is an application-layer control (signaling) protocol for creating, modifying and terminating sessions with one or more participants. The sessions can include Internet telephone calls, multimedia distribution and multimedia conferences. SIP invitations used to create sessions carry session descriptions that allow participants to agree on a set of compatible media types. SIP makes use of elements called proxy servers to help route requests to the user's current location, authenticate and authorize users for services, implement provider call-routing policies and provide features to users. SIP also provides a registration function that allows users to upload their current locations for use by proxy servers. SIP runs on top of several different transport protocols.

In “SIP-Specific Event Notification”, A. Roach, RFC 3265, July 2002, there is described a SIP event framework to enable event-based information provisioning to any node in the Internet. This procedure is expected to become a key element within the SIP infrastructure. Examples of this kind of information are presence, location information, content/service availability, or access-controlled SIP events, as described in several of the above-referenced related patent applications.

As is discussed in RFC 3265, the general concept is that entities in the network can subscribe to resource or call state for various resources or calls in the network, and those entities (or entities acting on their behalf) can send notifications when those states change. A typical flow of messages would be:

| Subscriber | Notifier |
|---|---|
| \|-----SUBSCRIBE---->\| | Request state subscription |
| \|<-------200--------------\| | Acknowledge subscription |
| \|<------NOTIFY---------\| | Return current state information |
| \|--------200------------->\| | Acknowledge |
| \|<------NOTIFY--------\| | Return current state information |
| \|--------200------------->\| | Acknowledge |

Subscriptions are expired and must be refreshed by subsequent SUBSCRIBE messages.

Several useful definitions include the following:

Event Package: An event package is an additional specification which defines a set of state information to be reported by a notifier to a subscriber. Event packages also define further syntax and semantics based on the framework defined by RFC 3265 that are required to convey such state information.

Event Template-Package: An event template-package is a special kind of event package which defines a set of states which may be applied to all possible event packages, including itself.

Notification: Notification is the act of a notifier sending a NOTIFY message to a subscriber to inform the subscriber of the state of a resource.

Notifier: A notifier is a user agent which generates NOTIFY requests for the purpose of notifying subscribers of the state of a resource. Notifiers typically also accept SUBSCRIBE requests to create subscriptions.

State Agent: A state agent is a notifier which publishes state information on behalf of a resource; in order to do so, it may need to gather such state information from multiple sources. State agents always have complete state information for the resource for which they are creating notifications.

Subscriber: A subscriber is a user agent which receives NOTIFY requests from notifiers; these NOTIFY requests contain information about the state of a resource in which the subscriber is interested. Subscribers typically also generate SUBSCRIBE requests and send them to notifiers to create subscriptions.

Subscription: A subscription is a set of application state associated with a dialog. This application state includes a pointer to the associated dialog, the event package name, and possibly an identification token. Event packages will define additional subscription state information. By definition, subscriptions exist in both a subscriber and a notifier.

Subscription Migration: Subscription migration is the act of moving a subscription from one notifier to another notifier.

The SUBSCRIBE method is used to request current state and state updates from a remote node.

J. Rosenberg has defined in “A Watcher Information Event Template-Package for the Session Initiation Protocol (SIP)”, draft-ietf-simple-winfo-package-05.txt, Jan. 31, 2003, a watcher information template-package for the SIP event framework. Watcher information in this context refers to a set of users that are subscribed to a particular resource within a particular event package. Watcher information changes dynamically as users subscribe, unsubscribe, are approved, or are rejected. A user can subscribe to this information, and therefore can learn of changes to this information. This particular event package is referred to as a template-package, as it can be applied to any event package, including itself.

However, the current IETF standardization process for extensions to the SIP event framework, namely the definition of particular event packages that are required for provisioning of particular information, is a complex and lengthy process. As can be appreciated, if the SIP event framework is used for a large variety of events, the unwieldy standardization process would soon become a significant bottleneck in the deployment of new SIP event based techniques.

This problem becomes even more onerous if the usage of SIP events is considered for information provisioning based on some dynamic or ambiguous application semantic, since the required consensus within the standardization body would significantly delay any deployment of the particular event package.

Based on the foregoing discussion, it can be appreciated that it is difficult to use SIP events for ambiguous or dynamically determined application semantics. As a consequence, it may be the case that SIP events are defined for rather simple, well-known, and therefore non-ambiguous semantics, such as presence, while more complex application semantics are assumed to be implemented within the SIP client (usually an end user or application). However, it would be desirable to enable more complex application semantics, such as in SIP event servers, through, as an example, the implementation of reasoning functionality and rule-based semantics. This would be useful in order to provide more complex, semantic-rich information through SIP events.

Exemplary reasons for the placement of such advanced functionality in the SIP event server include the following. In some cases, the SIP event server may have enhanced computational power and memory for implementing the desired advanced functionality. It may also be the case that the SIP event server has better, or even exclusive, access to resources that are required to implement the desired application semantic. It may also be the case that through the re-use of the realization of some certain application semantic, the cost of the entire service may be reduced.

As one exemplary scenario, a consideration is made of the provisioning of location information through SIP events. Apart from bare sensor information, one could possibly use SIP “location” events even for derived location information, such as city, county, or state. Further, the application may wish to demand the usage of certain sensors for the determination of the location, such as GPS derived location information or cellular telephone location information. Hence, it is not sufficient to subscribe to some “location” information without having an unambiguous agreement of the semantic of the information that will be provided by the SIP event server.

In another exemplary scenario, one could use SIP events to notify a user as to whether a particular user is “available”, and to use this information in, for example, making call routing decisions. However, the semantic of “available” depends on several factors. The decision as to whether a certain person is available might consider different input sources, such as schedule and location, schedule only, connectivity of certain devices, the presence or absence of other persons, current activity, or status of certain sensors (such as a tilt sensor on the phone to indicate that the phone has been placed face down in order to reject calls). Furthermore, the semantic might also depend on the current situation of the user. For instance, “available” might be differently defined in private situations as compared to business situations. Due to the variety of interpretations of the same event, it is required to have an unambiguous understanding of the semantic before a subscription can occur.

So-called ontologies provide a means to define application semantics that could be used to reach such unambiguous agreement of the required semantic. However, a perceived problem with the use of the current SIP event framework is that it does not provide a mechanism to associate or bind an application semantic to a particular event.

Apart from the desire to dynamically bind semantic information with SIP events, such as to provide highly application-specific information, it is also desirable to allow for changes in the semantic on the server side. This implies the use of methods for so-called semantic mediation in which services and the underlying semantic for performing these services requires adaptation due to changes in the environment (these changes, for example, could be caused by removal or addition of services, or by non-availability of certain input information). Reference with regard to semantic mediation can be made to Ora Lassila, “Serendipitous Interoperability”, in Eero Hyvönen (ed.): “The Semantic Web Kick-Off in Finland—Vision, Technologies, Research, and Applications”, HIIT Publications 2002-001, University of Helsinki, 2002. In this mediation process the typical event server can be expected to identify similar information providers based on semantic level similarities. Carefully adapting the environment based on the changed, similar semantic then would allow one to adapt the entire system to the change.

Consider now as an exemplary use case a change in context provider. Assume that a user has subscribed to an application-specific SIP event, which notifies the user once user A and user B come close to each other, and that further specifies that the location information of both user A and user B is determined by GPS-based location determination procedures. Assuming a proper semantic description of this case, the technique described in the above-referenced U.S. patent application by D. Trossen and D. Pavel, “Application Semantic Binding through SIP Event Package Template”, Ser. No. 10/465,455, filed Jun. 19, 2003, would allow for binding this semantic description to a SIP event, which can then be provided by a SIP server. Consider now further that throughout the subscription user A enters a building, making his/her tracking impossible via “normal” GPS (assume also that A-GPS is not available). A service logic within the SIP event server might determine that, based on an available in-house location system, the location of the user could still be determined. However, since the user specifically requested GPS location determination for user A, the SIP event server would not generate notifications to the subscriber, although another location-determining functionality was available.

Consider now another use case, specifically one that is associated with availability. Reviewing the above referenced example of subscribing to the availability of a particular user, assume that the subscriber desires notifications about the availability of a user by using certain input information to determine the availability (such as certain sensors on the user's phone). The method described in the above-referenced U.S. patent application Ser. No. 10/465,455 by D. Trossen and D. Pavel, “Application Semantic Binding through SIP Event Package Template”, can then be used to bind the particular “availability” semantic of the subscriber to the event subscription. Consider now that, for some reason, the required sensor information for determining “availability”, according to the agreed upon semantic, is no longer available to the SIP event server. However, assume further that the SIP event server is capable of determining a “similar” semantic for the desired “availability” semantic that would use other available input information (such as calendar information, or other, non-phone-based, sensors). However, since the user specifically requested that “availability” be determined based on the currently non-available input information, the SIP event server would not generate notifications to the subscriber, although other sources of suitable availability information may be present.

In both use cases, it would be desirable if there existed a technique to notify the subscriber of the changed semantics due to the presence of identified alternative services that could provide a similar functionality. Prior to this invention, this need was unfulfilled.

### SUMMARY OF THE PREFERRED EMBODIMENTS

The foregoing and other problems are overcome, and other advantages are realized, in accordance with the presently preferred embodiments of these teachings.

In one aspect this invention provides a method to subscribe to an event server in order to be notified of an occurrence of an event through a data communications network. The method includes sending a subscribe message from a subscriber to the event server, the subscribe message comprising information for specifying at least one application semantic; generating a first notification to the subscriber upon the at least one application semantic being satisfied and generating a second notification to the subscriber upon a change in the specified application semantic, enabling a substitution of the specified application semantic with another application semantic.

In a second aspect this invention provides an event notification system that includes a data communications network, at least one event server coupled to the data communications network and at least one subscriber coupled to the data communications network. The subscriber is operable to send a subscribe message to the event server, the subscribe message comprising information for specifying at least one application semantic. The event server is operable to generate a first notification to the subscriber upon the at least one application semantic being satisfied and to generate a second notification to the subscriber upon a change in the specified application semantic, enabling an occurrence of a substitution of the specified application semantic with another application semantic.

In another aspect this invention provides an event server that includes an interface for coupling to a data communications network and a control logic. The control logic is responsive to receipt of a subscribe message from a subscriber, that comprises information for specifying at least one application semantic, to generate a first notification to the subscriber upon the at least one application semantic being satisfied and to generate a second notification to the subscriber upon a change in the specified application semantic, for enabling an occurrence of a substitution of the specified application semantic with another application semantic.

In a further aspect this invention provides a subscriber unit that includes an interface for coupling to a data communications network and a control logic for generating a subscribe message that is sent via the data communications network to an event server. The subscribe message comprises information for specifying at least one application semantic. The control logic is responsive to a receipt of a first notification from the event server of the at least one application semantic being satisfied, and is further responsive to a receipt of a second notification from the event server upon a change in the specified application semantic, for enabling a substitution of the specified application semantic with another application semantic.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 shows the overall architecture and major logical entities of the present invention;

FIG. 2 shows a block diagram of the SIP event server of FIG. 1;

FIG. 3 illustrates various process steps and messages in accordance with the invention; and

FIG. 4 shows a conventional subscription state machine.

### DETAILED DESCRIPTION OF THE PREFERRED EMBODIMENTS

This invention provides a technique to notify a subscriber of a change of semantics due to the presence of at least one identified alternative information service that provides a functionality similar to an originally specified information service. For example, a currently available location information provider (e.g., cell location) is identified and substituted for an originally specified, but now unavailable location information provider (e.g., GPS). The SIP event server preferably determines an alternate information provider based on a “similar” semantic with respect to an original semantic, possibly using a semantic mediation technique. Once notified of the change in information provider the subscriber may elect to sustain the subscription or to terminate the subscription. The semantic description of the new information provider may further be used by the subscriber to adapt certain application behavior. For example, the application may change its interaction with the user, e.g., by requesting additional feedback when the newly provided information is less accurate than the information specified by the original subscription.

As will be made apparent below, this invention provides a method that allows for binding a particular application semantic to a particular SIP event. The invention also enables the dynamic generation of event packages based on a provided application semantic. This invention also supports the use of one or more ontology servers in order to enable sharing of common semantic among a set of users.

This invention relates to SIP events with highly application-specific semantics used for conveying context information to a subscriber. This invention enables the notification of changed semantics of the subscription from the SIP event server to the subscriber in a dynamic manner, enabling techniques for semantic mediation and application adaptation based on the changed semantic at the subscriber.

An aspect of this invention defines a SIP event package template, referred to as “bind”, with no event header field.

In accordance with this invention, when binding a particular application semantic to a particular event package, the potential subscriber sends a SUBSCRIBE to the desired event package, using the template “bind”, i.e., the requester subscribes to “package.bind”. The body of this subscription contains the application semantic description for the desired event. The subscription may also be provided through indirection methods, such as one described by S. Olson, “A Mechanism for Content Indirection in Session Initiation Protocol (SIP) Messages”, IETF Draft, Jun. 2, 2003, to utilize ontology servers for retrieving the semantic description.

The SIP event server obtains the ontology information, and confirms with a “200OK” when the required semantic is supported or sends back a failure message, which might contain reasons of the non-support (such as lack of resources, input, or other reasons).

This invention also allows for creating event packages dynamically by using an event template with the package name “generic”, i.e., subscribing to “generic.bind”. In this case, the entire required event package and event type information is extracted from the ontology information. Again, the SIP event server confirms the support of the ontology with “200OK”.

In both cases, the event server sends back in the first NOTIFY an identifier that is used by the potential subscriber for subscribing to the actual event package (and events), based on the agreed upon bound semantic. This (locally unique) identifier is then used by the event server to relate the subscription to the previously agreed upon application semantic. In case of a dynamically created event package, the generated event package description, i.e., the name of the package and the type or types of events, is also included in the NOTIFY message.

The potential subscriber in turn uses the provided identifier for subscriptions to the event package that is bound through this identifier to the provided application semantic.

In the case where the agreed upon semantic of the SIP event subscription has changed, the SIP event server sends a SIP NOTIFY message for the bind template within the particular subscription. The body of this NOTIFY message contains the changed semantic description. Alternatively, a link to an ontology server might be provided. In that case, content indirection methods, such as the one defined in the above-mentioned S. Olson, “A Mechanism for Content Indirection in Session Initiation Protocol (SIP) Messages”, IETF Draft, Jun. 2, 2003, can be used by the subscriber to retrieve the changed semantic description.

Based on the obtained changes of the semantic description for the particular subscription, the subscriber is enabled to engage in further operations, such as performing semantic mediation with other entities.

Referring to FIG. 1 there is shown a simplified architectural diagram of a system 10 that is suitable for practicing this invention. The system 10 includes a subscriber 12, local SIP proxies 14, 16 a network such as an Internet Protocol (IP) network 18, a SIP event server 20 and an ontology server 22. For the purposes of this invention ontologies can be considered to capture the semantics of information from various sources and to give them a concise, uniform and declarative description (see, for example, Y. Ding, D. Fensel, “Ontology Library Systems: The key to successful Ontology Re-use”, http://www.semanticweb.org/SWWS/program/full/paper58.pdf, August 2001). The SIP proxy 14 for the potential subscriber 12, and the SIP proxy 16 for the SIP event server 20, are each responsible for the handling of SIP messages, and for appropriately forwarding them to the specified entity. The ontology server 22 allows for the registering and querying of ontologies. The subscriber 12 is assumed to desire to subscribe to a particular SIP event with a particular application semantic, and may thus be referred to also as a potential subscriber. The SIP event server 20 implements SIP events and is assumed for convenience to be compliant with the procedures of “SIP-Specific Event Notification”, A. Roach, RFC 3265, July 2002. It is assumed that the SIP event server 20 is a candidate for subscription for the abovementioned potential subscriber 12.

In the presently preferred, but non-limiting embodiment of this invention the subscriber 12 is associated with a mobile wireless telecommunications device, such as a cellular telephone, or a personal communicator, or a mobile user or agent such as a computer that is coupled to the network 18 via a wireless link. The network 18 can comprise the Internet.

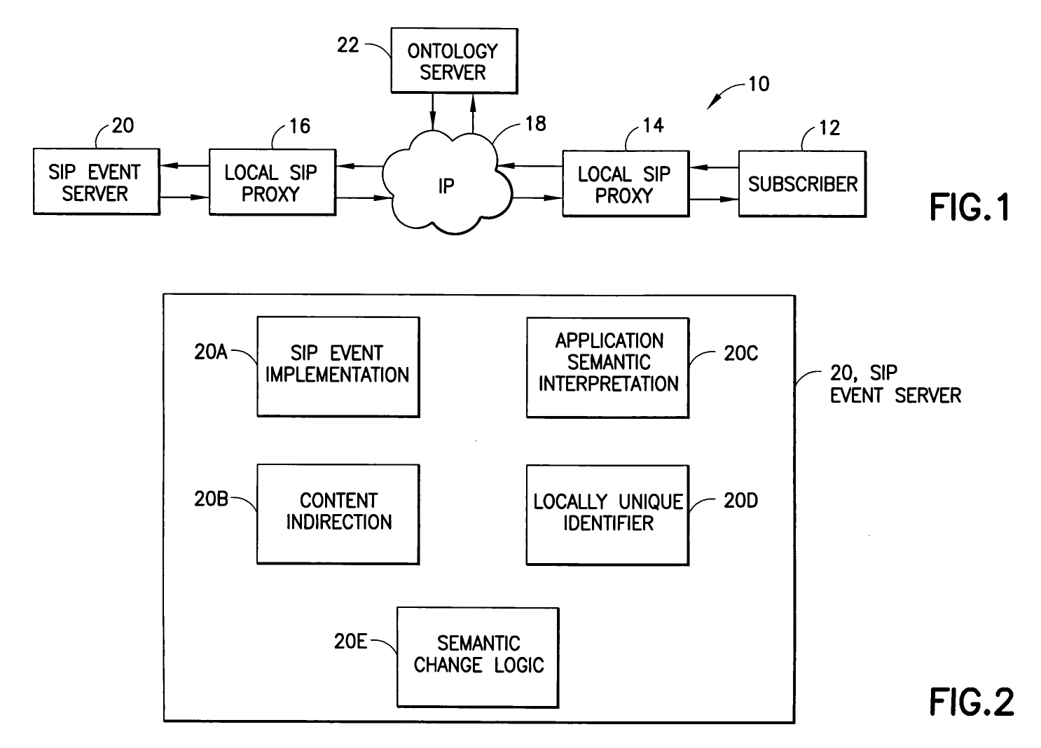

Referring to FIG. 2, in the presently preferred embodiment of this invention the SIP event server 20 further includes, apart from the functionality 20A that provides compliance with RFC 3265, the following functionalities.

The SIP event server 20 includes logic 20B that provides support for content indirection methods, such as in S. Olson, “A Mechanism for Content Indirection in Session Initiation Protocol (SIP) Messages”, IETF Draft, Jun. 2, 2003, or another suitable method for retrieving data from the ontology server 22 when the ontology server 22 is used to specify the application semantic.

The SIP event server 20 also provides logic 20C to interpret an application semantic provided to the SIP event server 20 through the application binding operation, as described below.

The SIP event server 20 also includes logic 20D that relates a locally unique identifier with the potential subscriber 12, the application semantic and the event package, either an existing event package for which the ambiguous semantic was resolved, or for a dynamically created event package. The logic 20D may, for instance, be implemented through a lookup procedure in a table of subscriber identifier, semantic identifier, and package name.

The SIP event server 20 also includes logic 20E for determining and specifying changes in the underlying semantic description for particular subscriptions. Such changes may occur for various reasons, such as changes in input information for the particular subscription. The SIP event server 20 can determine the changes in semantic, i.e., how the SIP event server implements its semantic mediation function, using any suitable technique.

The various logical blocks 20A-20E are preferably implemented as computer program modules executable by a data processor, although dedicated circuitry, or a combination of dedicated circuitry and computer programs, may be used as well.

It is assumed in the presently preferred embodiment of this invention that both the subscriber 12, also referred to as a subscriber unit, and the event server 20 include an interface to the network 18, and suitably programmed control logic for implementing this invention.

It should be noted with regard to FIG. 1 that the SIP proxies 14, 16 represent an embodiment of an entity that provides the forwarding of registration/subscription/notification, as provided by the SIP event framework. Other mechanisms could be used as well in other embodiments of the invention. However, in the following description the SIP event server 20 is discussed as the preferred embodiment, without restricting the general nature of the present invention.

An aspect of this invention defines a SIP event package template, referred to as “bind”, with no template-specific Event header field. In this context “bind” can be seen to be somewhat similar to the watcher information template described in the above-referenced “A Watcher Information Event Template-Package for the Session Initiation Protocol (SIP)”, draft-ietf-simple-winfo-package-05.txt, Jan. 31, 2003, by J. Rosenberg. The “bind” template can be applied to any other package. Two usage scenarios for the “bind” package template are now described.

A first usage scenario involves resolving ambiguous semantics of existing packages. In this case there is an ambiguous semantic for an existing SIP event package “foo”, and the “bind” template is used for this particular event package, denoted by “foo.binding”, similar to the usage of the watcher info template. The semantic binding operation, as discussed below, of the “bind” event package template is then used to resolve the ambiguous application semantic for the particular event package “foo”. An example for this case is this the location scenario discussed above.

A second usage scenario involves the dynamic creation of event packages. If an event package does not exist for the desired application semantic, the template can be used for dynamically creating such package. For this purpose the template is used together with a “generic” event package, denoted by “generic.binding”. The resulting package name plus supported events are then entirely determined based on the given application semantic. The package and event information of the dynamically created package is returned as a result of the semantic binding operation, as described below. An example for this case is the “availability” scenario that was discussed above.

It is not within the scope of this invention to specify exactly how the application semantic is defined. However, languages such as description logics, RDF, or other description languages can be employed.

In order to share such semantic information among a larger set of users, i.e., to create a common knowledge of semantic, the notion of ontology servers 22 is supported by the invention in the semantic binding operation, as discussed below.

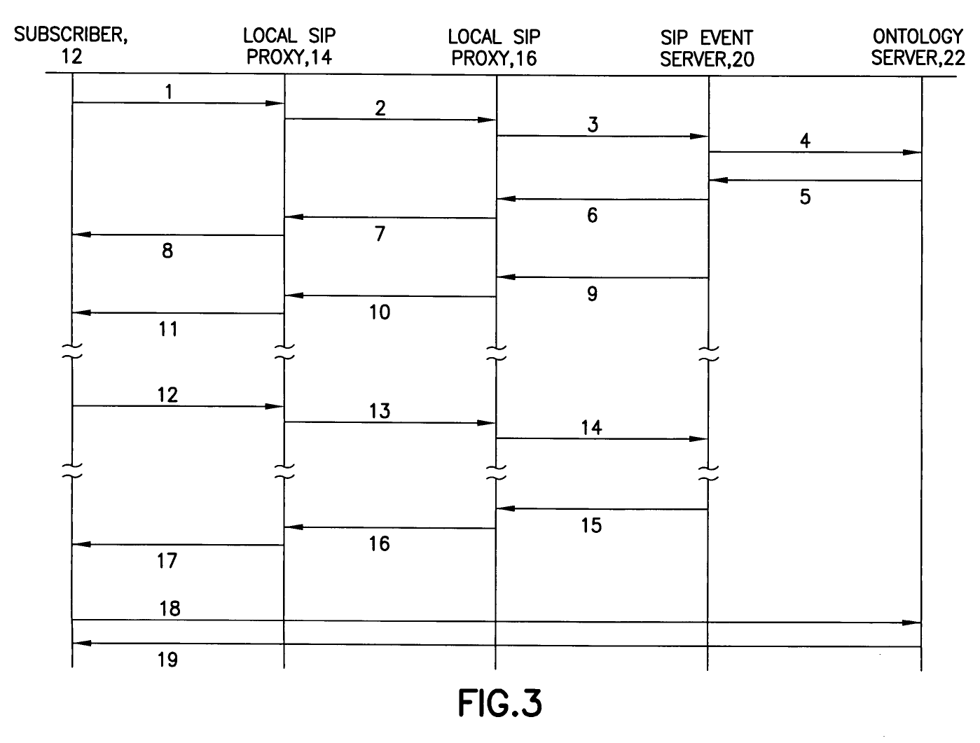

FIG. 3 shows the process steps and messages that are used for the binding of an application semantic to particular SIP events or to dynamically create event packages. FIG. 3 also shows the steps of notifying the subscriber 12 of changed semantics of the bound application semantic within an ongoing subscription.

When binding a particular application semantic to a particular event package, the subscriber 12 sends a SUBSCRIBE (message 1) to the SIP event server 20. In accordance with the non-limiting embodiment shown in FIG. 1, the SUBSCRIBE message is routed as message 2 and message 3 through the SIP proxies 14 and 16, respectively. Compliant with the template definition above, the subscription is performed using the “bind” package template. The body of this subscription contains: (a) the application semantic description desired by the subscriber 12, or (b) a URI of an ontology server 22 from which the application semantic can be retrieved. In the first case (a), the SIP event server 20 extracts the ontology information from the message body. In the second case (b), an indirection method, such as the one proposed by S. Olson, “A Mechanism for Content Indirection in Session Initiation Protocol (SIP) Messages”, IETF Draft, Jun. 2, 2003, can be used to retrieve the information from the ontology server 22 that is specified by the URI conveyed in the message body. In this latter case (b) the messages to and from the ontology server 22 are shown as messages 4 and 5.

After the SIP event server 20 obtains the ontology information (either directly as in case (a) above or through indirection as in case (b) above), it confirms the subscription in a manner compliant with “SIP-Specific Event Notification”, RFC 3265, July 2002, A. Roach. This subscription confirmation is shown as message 6, routed as message 7 and message 8 via the SIP proxies 14 and 16 to the subscriber 12, and is performed using a “200OK” when the required semantic is supported, or with a failure message if not supported. The failure message may contain reason(s) for the non-support, such as non-support of the application binding mechanism, or a lack of resources.

In the case where the subscriber 12 made a request to dynamically create the event package based on the provided semantic (through subscribing to the package “generic.bind”, see above), the required event package and event type information is extracted from the given semantic description and dynamically created within the SIP event server 20.

After the confirmation message is sent, the SIP event server 20 sends a first NOTIFY, preferably compliant with “SIP-Specific Event Notification”, RFC 3265, July 2002, A. Roach. This NOTIFY message is shown as message 9 in FIG. 3, which is routed as message 10 and 11 via the SIP proxies 14, 16 to the potential subscriber 12. This NOTIFY message can contain in its body at least one of the following message elements. A first message element is an identifier that is used by the subscriber 12 for subscribing to the actual event package (and events) with the bound semantic. This (locally unique) identifier is then used by the SIP event server 20, more specifically by the logic unit 20D, to relate the subscription to the previously agreed upon application semantic. In the case of a dynamically created event package, that is, in the case where the message 1 was a subscription for the event package “generic.bind”, the generated event package description, that is the name of the package and the types of events, is included in the body of the NOTIFY message 9.

In a case where the “bind” event package template subscription (sent as message 1 in FIG. 3) was a “one-shot” subscription compliant with RFC 3265, i.e., the duration value is set to zero, the SIP event server 20 does not store the subscription information for message 1 in FIG. 3. In this case the binding operation does not provide notification for changes of the semantic as described in messages 15 and beyond, as explained below. However, the SIP event server 20 stores the locally unique identifier and the event and subscriber information in order to link together the potential subscriber 12 and any future subscription to the event package bound to the provided application semantic.

In the case that the “bind” event package template subscription (sent as message 1 in FIG. 3) instead indicates a lifetime of non-zero, the SIP event server 20 creates appropriate subscription information for the “bind” event package template. The SIP event server 20 further stores appropriate information, such as the (locally unique) semantic identifier and the event and subscriber information discussed above, with the subscription information of the “bind” operation in order to relate the subscription appropriately to the semantic of the “bind” operation. Further, such information allows the SIP event server 20 to properly relate a semantic change to the subscriptions for which semantic changes would occur. Such semantic changes are explained in further detail below.

A future subscription of the subscriber 12 (shown as message 12 in FIG. 3, that is routed as messages 13 and 14 via the SIP proxies 14, 16 to the SIP event server 20) can include the locally unique identifier in order to link the subscription of the particular event package to the previously bound application semantic. This identifier may be provided through the “id” parameter of the “Event” header of the SUBSCRIBE message. For example, in Section 3.1.2 “Identification of Subscribed Events and Event Classes” of RFC 3265 it is stated that the Request URI of a SUBSCRIBE request contains enough information to route the request to the appropriate entity per the SIP request routing procedures. It also contains enough information to identify the resource for which event notification is desired, but not necessarily enough information to uniquely identify the nature of the event. Subscribers include exactly one “Event” header in SUBSCRIBE requests, indicating to which event or class of events they are subscribing. The “Event” header contains a token which indicates the type of state for which a subscription is being requested. The token corresponds to an event package which further describes the semantics of the event or event class. It is said that the “Event” header may also contain an “id” parameter. This “id” parameter, if present, is said to contain an opaque token that identifies the specific subscription within a dialog, and is only valid within the scope of a single dialog.

In another embodiment the locally unique identifier may be provided in the body of the SUBSCRIBE message.

In the case that the “bind” event package subscription for the particular semantic identifier was indicated with a lifetime of non-zero, the semantic identifier is used to relate the subscription in message 12 with the “bind” event package subscription. It should be noted however, and as was mentioned above, for the case that the “bind” event package subscription for the particular semantic identifier was indicated with a lifetime of zero, the semantic identifier and the event identifier are still stored, and can thus be used for future subscriptions to the event. In practice, the only real distinction between the lifetime of zero and lifetime of non-zero cases is that for the lifetime of zero case the subscriber 12 is not notified if the underlying semantics have changed. The subscriber 12 can, however, still subscribe to the event.

As was discussed above, changes may occur within the SIP event server 20 that would require changes to the semantics of ongoing (application-specific) SIP event subscriptions (said application-specific subscriptions created through steps described above). For example, certain input information that was specified in the semantic description of message 1 in FIG. 3 may no longer be available. In accordance with an aspect of this invention, the SIP event server 20 includes the semantic change logic 20E and is able to determine the necessary changes in the semantic description. For example, the SIP event server 20 is able to determine an alternative input information that would lead to a “similar” result of the subscription. Such a change in the semantic of the subscription is preferably conveyed to the subscriber 12.

For this purpose the SIP event server 20 generates a SIP NOTIFY (message 15 in FIG. 3, routed as messages 16 and 17 to the subscriber 12) for the event package template “bind” of the particular SIP event subscription whose semantic has changed. The body of the subscription contains either an appropriate description of the changed semantic or the body contains a URI of the ontology server 22 from which the changed semantic description can be retrieved.

Upon reception of message 17 the subscriber 12 extracts the included semantic description from the message body. In the second case noted above, where the URI of the ontology server 22 is returned in the message 17, content indirection methods, such as those discussed by S., Olson, “A Mechanism for Content Indirection in Session Initiation Protocol (SIP) Messages”, IETF Draft, Jun. 2, 2003, can be used to retrieve the information from the ontology server 22. This exchange is shown as message 18 and 19 in FIG. 3.

Due to the use of the event package template, the subscriber 12 is enabled to associate the obtained semantic description to the particular SIP event subscription for which the semantic has changed. This can be accomplished in manner that is somewhat similar to the technique for how watcherinfo notifications can be related to the information for which the watcherinfo is retrieved, as discussed by J. Rosenberg, “A Watcher Information Event Template-Package for the Session Initiation Protocol (SIP)”, draft-ietf-simple-winfo-package-05.txt, Jan. 31, 2003.

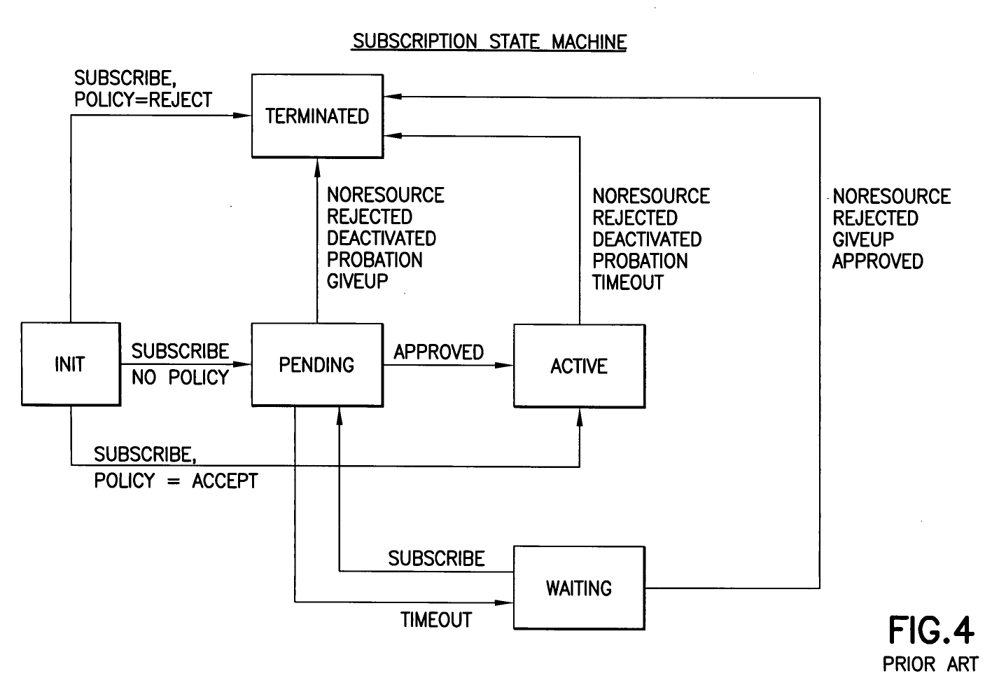

Discussing this now in further detail, the conventional watcherinfo notifications may be generated for watcher information on package foo, when the subscription state for a user on package foo changes. The watcher information package therefore needs a model of subscription state. This is accomplished by specifying a subscription Fine State Machine (FSM), described below and shown herein in FIG. 4, which governs the subscription state of a user in any package. Watcherinfo notifications may be generated on transitions in the FSM. It is pointed out that the FSM is just a model of the subscription state machinery maintained by a server, and a specific implementation would map its own state machines to the FSM in an implementation-specific manner.

FIG. 4 illustrates the underlying FSM for a subscription. It is derived almost entirely from the descriptions in RFC 3265, but adds the notion of a waiting state. Initially, there is no state allocated for a subscription (the init state). When a SUBSCRIBE request arrives, the subscription FSM is created. The next state depends on whether policy exists for the subscription. If there is an existing policy that determines that the subscription is forbidden, it moves into the terminated state immediately, where the FSM can be destroyed. If there is existing policy that determines that the subscription is authorized, the FSM moves into the active state. This state indicates that the subscriber will receive notifications. If, when a subscription arrives, there is no authorization policy in existence, the subscription moves into the pending state. In this state, the server is awaiting an authorization decision. No notifications are generated on changes in presence state (an initial NOTIFY will have been delivered as per RFC 3265), but the subscription FSM is maintained. If the authorization decision comes back positive, the subscription is approved, and moves into the active state. If the authorization is negative, the subscription is rejected, and the FSM goes into the terminated state. It is possible that the authorization decision can take a very long time. In fact, no authorization decision may arrive until after the subscription itself expires. If a pending subscription suffers a timeout, it moves into the waiting state. At any time, the server can decide to end a pending or waiting subscription because it is concerned about allocating memory and CPU resources to an unauthorized subscription state. If this occurs a “giveup” event is generated by the server, moving the subscription to termination. The waiting state is similar to pending, in that no notifications are generated. However, if the subscription is approved or denied, the FSM is destroyed. The purpose of the waiting state is so that a user can fetch watcherinfo state at any time, and learn of any subscriptions that arrived previously (and which may arrive again) which require an authorization decision. The waiting state is also needed to allow for authorization of fetch attempts, which are subscriptions that expire immediately.

The server may generate a notification to watcherinfo subscribers on a transition of the FSM, although whether it does or not is policy dependent. However, several guidelines are defined by Rosenberg in this regard. Consider some event package foo. A subscribes to B for events within that package. A also subscribes to foo.winfo for B. In this scenario (where the subscriber to foo.winfo is also a subscriber to foo for the same resource), it is recommended that A receive watcherinfo notifications only about the changes in its own subscription. Normally, A will receive notifications about changes in its subscription to foo through the Subscription-State header field, which frequently obviates the need for a separate subscription to foo.winfo. However, if such a subscription is performed by A, the foo.winfo notifications should not report any state changes which would not be reported (because of authorization policy) in the Subscription-State header field in notifications on foo. As a general rule, when a watcherinfo subscriber is authorized to receive watcherinfo notifications about more than one watcher, it is recommended that watcherinfo notifications contain information about those watchers which have changed state (and thus triggered a notification), instead of delivering the current state of every watcher in every watcherinfo notification. However, watcherinfo notifications triggered as a result of a fetch operation (a SUBSCRIBE with Expires of 0) should result in the full state of all watchers (only those watchers that have been authorized to be divulged to the watcherinfo subscriber) to be present in the NOTIFY.

As was stated above, the semantic change notification may be reported to the subscriber 12, in accordance with this invention, using a procedure that may be similar to that used for the watcherinfo notifications, as summarized above.

In the case where the subscriber 12 does not agree with the change in semantics by the SIP event server 20 (for any reason), the subscriber 12 might cease the subscription, compliant to the procedures outlined in RFC 3265. Otherwise, the subscriber 12 may use the obtained changed semantic description for performing application-specific tasks, such as semantic mediation with other entities (e.g., other services of the application relying on the information provided in the subscription), or the subscriber 12 may simply render the change of semantics to the user (e.g., by displaying a notification of the change on the user's display).

The use of this invention allows for dynamic changes to occur in the semantic of ongoing, application-specific SIP event subscriptions. The change in semantic is conveyed to the subscriber 12 in order to enable application-specific steps to be performed to deal with the change. Since input information and, therefore, potentially the semantic of context information provided through application-specific SIP events can change very easily in ubiquitous computing scenarios, the SIP event-based support for such changes, based on semantic mediation, can be seen to be a significant advance over the prior art.

This invention provides a capability for the event server, preferably the SIP event server 20, to accommodate a situation where an information provider or providers disappear or appear, and employs semantic mediation techniques in order to identify a new, similar information provider. Upon receiving an application semantic change notification, the subscriber 12 may adapt its application logic based on the received semantic change.

The various messages that flow between the event server 20 and the subscriber 12 can have various formats. In the preferred embodiment the message format and protocol are compliant with RFC3265, although application-specific and application area-specific messaging formats can be employed (as one example, Sensor Mark-Up Language (SensorML)). In the exemplary case of RFC3265, and as was noted above, the message body is used to convey the information in accordance with this invention. The invention may employ, as one example, XML to convey the information.

The presently preferred embodiment of this invention communicates a desired application semantic from the client 12 to the event server 20, which then verifies the support for the semantic from the server side.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent message type and formats, and network architectures, may be attempted by those skilled in the art. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

1. A method to subscribe to an event server to be notified of an occurrence of an event through a data communications network, comprising:
sending a subscribe message from a subscriber to the event server, the subscribe message comprising information for specifying at least one application semantic;
generating a first notification to the subscriber upon the at least one application semantic being satisfied; and
generating a second notification to the subscriber upon a change in the specified application semantic, enabling a substitution of the specified application semantic with another application semantic.

2. A method as in claim 1, where the information comprises an application semantic description for enabling the event server to extract ontology information.

3. A method as in claim 1, where the information comprises an address of an ontology server from which ontology information can be retrieved.

4. A method as in claim 1, where the subscribe message employs a “bind” event package-template for associating a particular application semantic with a particular event package.

5. A method as in claim 1, where the subscribe message employs a “generic-bind” event package-template for dynamically creating at the event server a desired event package with event type information, further comprising extracting information from the message that specifies the desired event package and event type information.

6. A method as in claim 1, where the second notification is generated only if a duration associated with the subscribe message is non-zero.

7. A method as in claim 4, further comprising sending a message to the subscriber from the event server that includes a locally unique identifier that is used by the event server to relate the subscription to the application semantic.

8. A method as in claim 5, further comprising sending a message to the subscriber from the event server that includes a description of the dynamically created event package.

9. A method as in claim 4, where for a case where a duration associated with the subscribe message is one of zero or non-zero the method further comprises storing with the event server a locally unique identifier, associated with the subscriber, in association with subscription information so as to link the subscription of the particular event package to a previously bound application semantic.

10. A method as in claim 1, where the information comprises an address from which ontology information can be retrieved using a content indirection procedure.

11. A method as in claim 1, where said second notification is sent upon the event server determining a change in the description of the application semantic.

12. A method as in claim 1, where the second notification comprises a description of the changed application semantic.

13. A method as in claim 1, where the second notification comprises an address of a server from which a description of the changed application semantic can be retrieved using a content indirection procedure.

14. A method as in claim 1, where the event server comprises a Session Initiation Protocol (SIP) event server.

15. An event notification system comprising a data communications network, at least one event server coupled to the data communications network, and at least one subscriber coupled to the data communications network, where said subscriber is operable to send a subscribe message to the event server, the subscribe message comprising information for specifying at least one application semantic; and where said event server is operable to generate a first notification to the subscriber upon the at least one application semantic being satisfied and to generate a second notification to the subscriber upon a change in the specified application semantic, enabling an occurrence of a substitution of the specified application semantic with another application semantic.

16. An event notification system as in claim 15, where the information comprises an application semantic description for enabling the event server to extract ontology information.

17. An event notification system as in claim 15, further comprising at least one ontology server coupled to the data communications network, where the information comprises an address of said ontology server from which ontology information can be retrieved.

18. An event notification system as in claim 15, where the subscribe message employs a “bind” event package-template for associating a particular application semantic with a particular event package.

19. An event notification system as in claim 15, where the subscribe message employs a “generic-bind” event package-template for dynamically creating at the event server a desired event package with event type information, said event server being further operable to extract information from the message that specifies the desired event package and event type information.

20. An event notification system as in claim 15, where the second notification is generated only if a duration associated with the subscribe message is non-zero.

21. An event notification system as in claim 18, where said event server is further operable to send a message to the subscriber that includes a locally unique identifier that is used by the event server to relate the subscription to the application semantic.

22. An event notification system as in claim 19, where said event server is further operable to send a message to the subscriber that includes a description of the dynamically created event package.

23. An event notification system as in claim 18, where for a case where a duration associated with the subscribe message is one of zero or non-zero said event server is further operable to store a locally unique identifier, associated with the subscriber, in association with subscription information so as to link the subscription of the particular event package to a previously bound application semantic.

24. An event notification system as in claim 15, where the information comprises an address from which ontology information can be retrieved using a content indirection procedure.

25. An event notification system as in claim 15, where the second notification comprises a description of the changed application semantic.

26. An event notification system as in claim 15, where the second notification comprises an address of a server from which a description of the changed application semantic can be retrieved using a content indirection procedure.

27. An event notification system as in claim 15, where the event server comprises a Session Initiation Protocol (SIP) event server.

28. An event notification system as in claim 27, further comprising a at least one SIP proxy interposed between at least one of said SIP event server and said subscriber.

29. An event notification system as in claim 15, where said subscriber is associated with a mobile wireless telecommunications device.

30. An event server, comprising an interface for coupling to a data communications network and a control logic, responsive to receipt of a subscribe message from a subscriber that comprises information for specifying at least one application semantic, to generate a first notification to the subscriber upon the at least one application semantic being satisfied and to generate a second notification to the subscriber upon a change in the specified application semantic, enabling an occurrence of a substitution of the specified application semantic with another application semantic.

31. An event server as in claim 30, where the information comprises an application semantic description for enabling the event server to extract ontology information.

32. An event server as in claim 30, where the subscribe message employs a “bind” event package-template for associating a particular application semantic with a particular event package.

33. An event server as in claim 30, where the subscribe message employs a “generic-bind” event package-template for dynamically creating at the event server a desired event package with event type information, said event server being further operable to extract information from the message that specifies the desired event package and event type information.

34. An event server as in claim 30, where said event server is operable to send the second notification in response to determining a change in a description of the application semantic.

35. An event server as in claim 30, where the second notification comprises a description of the changed application semantic.

36. An event server as in claim 30, where the second notification comprises an address of a server from which a description of the changed application semantic can be retrieved using a content indirection procedure.

37. An event server as in claim 30, where said event server comprises a Session Initiation Protocol (SIP) event server.

38. An event server as in claim 32, where for a case where a duration associated with the subscribe message is one of zero or non-zero said event server is further operable to store a locally unique identifier, associated with the subscriber, in association with subscription information so as to link the subscription of the particular event package to a previously bound application semantic.

39. A subscriber unit, comprising an interface for coupling to a data communications network and a control logic for generating a subscribe message that is sent via the data communications network to an event server, the subscribe message comprising information for specifying at least one application semantic, said control logic being responsive to a receipt of a first notification from the event server of the at least one application semantic being satisfied, and being further responsive to a receipt of a second notification from the event server upon a change in the specified application semantic for enabling a substitution of the specified application semantic with another application semantic.

40. A subscriber unit as in claim 39, where the information comprises an application semantic description for enabling the event server to extract ontology information.

41. A subscriber unit as in claim 39, where the subscribe message employs a “bind” event package-template for associating a particular application semantic with a particular event package.

42. A subscriber unit as in claim 39, where the subscribe message employs a “generic-bind” event package-template for dynamically creating at the event server a desired event package with event type information, said event server being further operable to extract information from the message that specifies the desired event package and event type information.

43. A subscriber unit as in claim 39, where the second notification is received in response to a change in a description of the application semantic, and where the second notification comprises a description of the changed application semantic.

44. A subscriber unit as in claim 39, where the second notification comprises an address of a server from which a description of the changed application semantic can be retrieved using a content indirection procedure.

45. A subscriber unit as in claim 39, where said subscriber unit is associated with a mobile wireless telecommunications device.

46. A subscriber unit as in claim 41, where for a case where a duration associated with the subscribe message is one of zero or non-zero the event server is operable to store a locally unique identifier, associated with the subscriber unit, in association with subscription information so as to link the subscription of the particular event package to a previously bound application semantic.

47. A computer program product embodied on or in a computer-readable data storage medium execution of which directs at least one data processor to subscribe to an event server so as to be notified through a data communications network of an occurrence of an event, comprising operations of:
sending a subscribe message from a subscriber to the event server, the subscribe message comprising information for specifying at least one application semantic;
generating a first notification to the subscriber upon the at least one application semantic being satisfied; and
generating a second notification to the subscriber upon a change in the specified application semantic, enabling a substitution of the specified application semantic with another application semantic.

48. A computer program product as in claim 47, where the information comprises an application semantic description for enabling the event server to extract ontology information.

49. A computer program product as in claim 47, where the information comprises an address of an ontology server from which ontology information can be retrieved.

50. A computer program product as in claim 47, where the subscribe message employs a “bind” event package-template for associating a particular application semantic with a particular event package.

51. A computer program product as in claim 47, where the subscribe message employs a “generic-bind” event package-template for dynamically creating at the event server a desired event package with event type information, further comprising extracting information from the message that specifies the desired event package and event type information.

52. A computer program product as in claim 47, where the second notification is generated only if a duration associated with the subscribe message is non-zero.

53. A computer program product as in claim 50, further comprising sending a message to the subscriber from the event server that includes a locally unique identifier that is used by the event server to relate the subscription to the application semantic.

54. A computer program product as in claim 51, further comprising sending a message to the subscriber from the event server that includes a description of the dynamically created event package.

55. A computer program product as in claim 50, where for a case where a duration associated with the subscribe message is one of zero or non-zero the method further comprises storing with the event server a locally unique identifier, associated with the subscriber, in association with subscription information so as to link the subscription of the particular event package to a previously bound application semantic.

56. A computer program product as in claim 47, where the information comprises an address from which ontology information can be retrieved using a content indirection procedure.

57. A computer program product as in claim 47, where said second notification is sent upon the event server determining a change in the description of the application semantic.

58. A computer program product as in claim 47, where the second notification comprises a description of the changed application semantic.

59. A computer program product as in claim 47, where the second notification comprises an address of a server from which a description of the changed application semantic can be retrieved using a content indirection procedure.

60. A computer program product as in claim 47, where the event server comprises a Session Initiation Protocol (SIP) event server.
